(19) United States
(12) Patent Application Publication
(10) Pub. No.: US 2008/0053286 A1
(43) Pub. Date: Mar. 6, 2008

(54) Harmonious Music Players

(76) Inventor: Mordechai Teicher, Hod-Hasharon (IL)

Correspondence Address: MR. MORDECHAI TEICHER;CREATIVE INPUTS LTD., PO BOX 991, KFAR-SABA, ISRAEL, 44109, omitted

(21) Appl. No.: 11/550,466

(22) Filed: Oct. 18, 2006

Related U.S. Application Data
(60) Provisional application No. 60/824,615, filed on Sep. 6, 2006.

(51) Int. Cl. G10F 1/22

(52) U.S. Cl. 84/2

(57) ABSTRACT

Music players, for example musical toys, have loudspeakers. Each player stores a part of an orchestrated composition. A conductor unit, that can be a standalone unit or form part of one of the players, activates the players to synchronously play their parts thus playing the composition harmoniously.

### CROSS REFERENCE TO RELATED APPLICATION

This application claims the benefit of U.S. provisional patent application 60/824,615 filed on 6 Sep. 2006.

### BACKGROUND OF THE INVENTION

1. Field of the Invention

The present invention relates to electronic music players, and in particular to portable electronic music players that have a loudspeaker.

2. Description of Related Art

Music is an art concerned with producing sounds for beauty of form and emotional expression, usually according to cultural standards of rhythm, melody, and harmony. For multiple musical pieces to be combined in a pleasing manner, they need to be harmonized and played in tempo.

Portable electronic music players, in the form of toys, computerized appliances and portable computers, are commonplace. Many portable electronic music players include a loudspeaker that produces sounds in the vicinity of the player. However, when several portable electronic music players are brought together and made to sound simultaneously, the result is usually unpleasant, since the played tunes may be unrelated to one another, may be played out of key, and may be played out of tempo.

There is therefore a need for systems and functionalities that enable harmonious playback of sounds from a plurality of portable electronic music players.

### BRIEF SUMMARY OF THE INVENTION

The present invention seeks to provide systems and functionalities for coordinating music playing among a plurality of portable electronic music players for harmoniously playing orchestrated musical compositions.

### Definitions

By “portable electronic music player”, “music player” or “player” is meant a battery-operated standalone portable electronic device that stores one or more music pieces and has a loudspeaker for producing the sounds of these music pieces to be heard in the vicinity of the device. Exemplary players include musical toys, portable computerized appliances and portable computers.

By “music piece” is meant a digital representation of recorded or synthesized music, to be stored in and played by a player. Such a digital representation can be based, for example, on protocols known in the art such as MP3 or MIDI. A music piece can include representations of sounds representative of one musical instrument or several musical instruments.

By “playing” is meant the operation of one or more players for producing the sounds of music pieces stored therein.

By “harmony” or “harmonious” is meant the effect of cooperatively playing a plurality of music pieces, in a predefined manner devised for creating a pleasing effect for listeners. Harmony can be accomplished, for example, by playing identical or similar music pieces synchronously (“unison”), applying a predetermined time shift between compatible identical or similar pieces (“canon”), assigning different parts of a musical composition to different players, or accompanying an existing composition with extra tunes. By “similar music pieces” is meant tunes that differ by an octave, or identical tunes having different timbres (e.g. produced by players that mimic a violin and a piano).

The term “orchestrated musical composition”, “orchestrated composition” or “composition” denotes herein a set of two or more music pieces that are devised by their composer or arranger for synchronous playing to achieve harmony. A composition, as applied herein, must be orchestrated or arranged to include at least two different music pieces, or at least two identical or similar music pieces that are played in canon. Thus, a unison that is common to all participating players throughout their entire respective music pieces is not considered a composition in the context of the present invention; however, a composition does allow some of the players play in unison, analogous, for example, to several 1st violins in a real symphonic orchestra. It will be emphasized that a composition may relate to all music styles, including classical, pop, jazz, children's melodies, etc.

By “playlist” is meant a list of one or more compositions to be played. If more than one composition is included in a playlist, the playlist may also specify the order of playing or that the compositions are to be played in random order.

### SUMMARY

In its broadest sense, the present invention provides systems and functionalities for operating a plurality of music players harmoniously by synchronously activating the music players from a conductor unit. Preferably, the systems stores a plurality of orchestrated compositions, and the user can determine which orchestrated composition will be played, or even select a playlist determining orchestrated compositions to be played in a predefined or random order.

Since harmony is a subjective concept, it will be understood that harmonious playing is accomplished when a orchestrated composition is composed or arranged in parts, at least two of the parts are different or are played at different timing (canon), and the parts are then played by a plurality of players synchronously and in tempo.

There is thus provided, according to a preferred embodiment of the present invention, a system for playing music. The system comprises a plurality of players (i.e. at least two players) that are portable and distinct from each other, each having its own speaker (or speakers). Each of the players includes a music store, such as a memory device that stores a music piece assigned to that music player; for example, if the music player has the role of a piano, it is preferably assigned a music piece which is the piano part of a selected orchestrated composition. The system also includes a conductor unit that is operative to activate each of the players to synchronously play its music piece, so that the sounds heard collectively from all players join and combine in harmony. At least two of the sounded music pieces are different or are played in different timing to make the harmony meaningful. The conductor unit can be a standalone unit that is separate from the players, or it can form part of one of the players that both plays its part and activates the other players. It is also possible that more than one player includes conductor functionality, and then the actual conductor is determined by the user operating the controls of the selected unit. In addition to activating the music players, the conductor unit can optionally and preferably pause, resume and stop all players upon receiving the appropriate user commands.

The orchestrated composition that is played is either a single orchestrated composition stored in the system, or one of a plurality of orchestrated compositions, selected at the conductor unit. In the latter case, the conductor unit is also operative to determine which orchestrated composition will be played, or even receive a playlist of several orchestrated compositions to be played in a predefined or random order. A user interface allows the user control the conductor unit operation thus determining which music will be played, at what order and when to start.

Preferably, the music pieces, after being orchestrated by a composer or an arranger and digitized, are stored in a central storage device—the music origin. In some embodiments, the music pieces from the music origin are installed in all players individually, while in other embodiments the music pieces are installed in the conductor unit, and are sent to the players toward their activation. The music stores of the players and/or the conductor unit are either preloaded in the factory, supplied as removable cartridges, or receive content downloaded via the Internet or mobile networks.

Also provided is a method for playing music. The method starts with installing, in each music player from a plurality of portable music players, a music piece related to a selected orchestrated composition from a number of orchestrated compositions. Subsequently, each music player is activated to synchronously play the music piece installed therein and related to the selected orchestrated composition. One or more orchestrated compositions can be included in the system; in case of several orchestrated compositions, the method also allows determining the orchestrated composition to be played, or even receiving a playlist of orchestrated compositions to be played in a predefined or random order. Optionally the method also allows sending the selected music pieces to the players toward their activation. Preferably, the method also includes receiving user commands to affect the activation of the players and/or the determination of the composition or playlist to be played.

### BRIEF DESCRIPTION OF SEVERAL VIEWS OF THE DRAWINGS

The present invention will be understood and appreciated more fully from the following detailed description, taken in conjunction with the drawings in which:

FIGS. 1-3 are simplified block diagrams of systems according to three preferred embodiments of the present invention.

FIGS. 4-6 are simplified block diagrams of music players that form part of the systems of FIGS. 1-3.

FIG. 7 is a simplified block diagram of a conductor unit that forms part of the system of FIG. 1.

FIGS. 8A-8B are simplified flowcharts describing the process of installing music in the preferred embodiments of FIGS. 1-3.

FIGS. 9A-9B are simplified flowcharts describing the process of playing music in the preferred embodiments of FIGS. 1-3.

FIG. 10 is a table schematically describing the distribution, to a plurality of players, of music pieces related to several compositions.

FIGS. 11A-11C are simplified block diagrams describing exemplary user interfaces of conductor units according to preferred embodiments of the present invention.

### DETAILED DESCRIPTION OF THE INVENTION

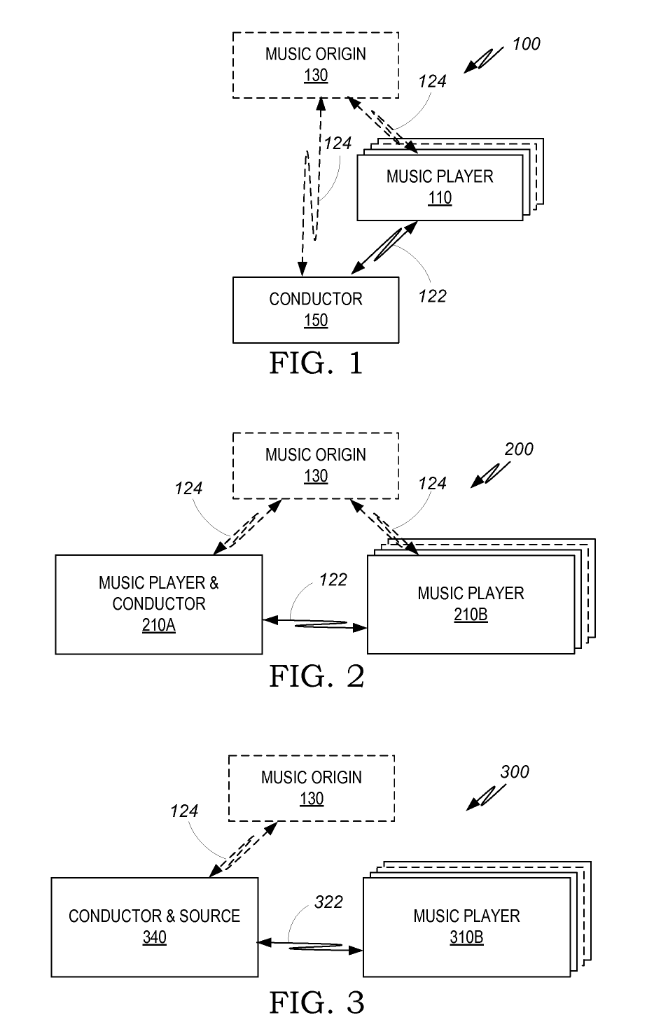

Reference is made to FIG. 1 which depicts a first preferred embodiment of the present invention. System 100 includes a plurality of music players 110. Conductor 150 is a user-operable standalone unit that activates music players 110. Conductor 150 includes a user interface for activating and controlling the operation of music players 110. The plurality of music players 110 includes at least two players. For clarity, system 100 can be visualized as a toy set, which includes, for example, one piano-shaped, two violin-shaped, one cello-shaped and one viola-shaped music players 110, and a podium-shaped conductor unit 150.

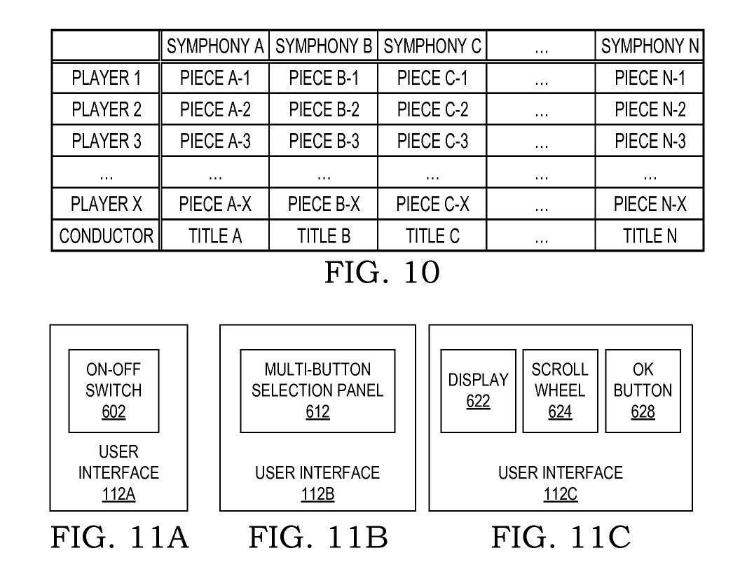

Music origin 130 is a remote storage device, such as a production-line server, Internet server or mobile-network server, which includes electronic music pieces, derived from orchestrated musical compositions, which are suitable for being harmoniously played by music players 110. Each of music players 110 has its own speaker (or speakers) and power source. The music pieces are copied to the storage devices of music players 110; such copying can be made at the production facility of the music players, or later by the user downloading music pieces from music origin 130 via the Internet or a mobile communication network; alternatively, music pieces can be provided from music origin 130 to music players 110 by using hardware cartridges that receive content from music origin 130 and are then plugged into the respective music players. In some embodiments, more than one music origin 130 can exist for receiving music pieces therefrom. Music origin 130 optionally provides also conductor 150 with a music catalog that includes the titles of the music compositions that are included in pieces in music players 110 (see FIG. 10). Alternatively to sending a catalog from music origin 130 to conductor 150 through link 124, such catalog can be retrieved by conductor 150 from music players 110 via links 122; this provides for accurate up-to-date synchronization between the catalog within conductor 150 and the music contained in the actual music players 110 communicating with conductor 150. Communication link 124 can be based on a contact bus during manufacturing of music players 110 and conductor 150, or be realized by memory cartridges, or use techniques known in the art for downloading electronic content to electronic appliances via the Internet or mobile communication networks, which may involve intermediaries such as a personal computer or cellular telephone, that are not shown herein. Link 122 is preferably a short-range non-contact link for controlling the operation of music players 110 from conductor 150, using communication carriers such as RF (radio frequency), IR (infra red) or ultrasound. Alternatively, link 122 can use wired communication, for example if the present invention is implemented in a Lego-like toy set.

FIG. 2 describes another preferred embodiment of a system 200, where the functionality of conductor 150 of FIG. 1 is carried out by a music player & conductor 210A that includes both player and conductor functionalities. Thus, in an example where music player & conductor 210A is a piano-shaped toy that plays the piano part of a composition, it also includes the user controls, data and communication interfaces needed to activate and synchronize one or more music players 210B that are shaped as other instruments and play their respective parts of the composition. Link 122 and link 124 are as depicted with respect to FIG. 1.

It will be noted that the dual functionality of music player & conductor 210A as a player and a conductor, may be implemented in a specific single player (e.g. the piano toy), or may be included also in other players from music players 210B, and the user may then select the controls of which of the players to use in order to activate and operate the other players of system 200, making the selected player the actual music player & conductor 210A of FIG. 2.

It will also be noted that the way conductor 150 of FIG. 1 or music player & conductor 210A of FIG. 2 activates the players to synchronously play their parts may vary according to technical design considerations. In some embodiments the conductor unit just triggers a synchronous start of all players (and optionally also controls synchronous pause, resume and stop operations), and the internal clocks of the players' electronics are sufficiently accurate to ensure continual synchronization among the players; in other embodiments the conductor unit may send intermittently a sync signal; in some cases, where a player needs to join a composition at a predetermined moment after that composition has started, as is the cases with canons, such player can be either triggered simultaneously with the rest and count idle time before joining, or the conductor can activate that player on time. Thus, the conductor functionality can vary from the simultaneous triggering of start, pause, resume and stop, to a more sophisticated management of each player individually according to an electronic music score loaded into the conductor.

In the preferred embodiment of FIG. 3, system 300 includes a conductor & source 340 that functions as both a conductor (like conductor 150 of FIG. 1 or music player & conductor 210A of FIG. 2) and a storage that serves as a source of all music pieces for all music players 310B. Thus, instead of providing the respective parts to each of the music players from music origin 130, as done in FIGS. 1-2, in the present embodiment all music pieces of a plurality of compositions are copied, either during manufacturing, or by using a hardware memory cartridge, or through an Internet or mobile download, to conductor & source 340. This configuration supports an operational mode where conductor & source 340 first distributes the various parts of a selected orchestrated composition to respective music players 310B, and then system 300 is ready for operation through user controls included in conductor & source 340, similarly to the operation of system 100 or 200 of FIG. 1 or 2, respectively. Link 124 is used to load music from music origin 130 to conductor & source 340 either during the manufacturing of music player 310A, or via a cartridge, or by subsequent downloads. Link 322 uses RF or IR or wired communication to download music pieces related to a selected orchestrated composition to the respective music players 310B and then selectably activate them.

It will be noted that the embodiment of FIG. 3 manages centrally all music pieces that are played by all music players. This is more demanding for the performance of conductor & source 340 and link 322, but simplifies downloading new music pieces from music origin 130 since one download (or a single cartridge) is sufficient for the entire system, instead of providing separate downloads or cartridges for each player individually. Also, it allows using music players having minimal storage (that can be nonvolatile or volatile storage) for only a single music piece, while several compositions are available to the user through storing multiple compositions in conductor & source 340.

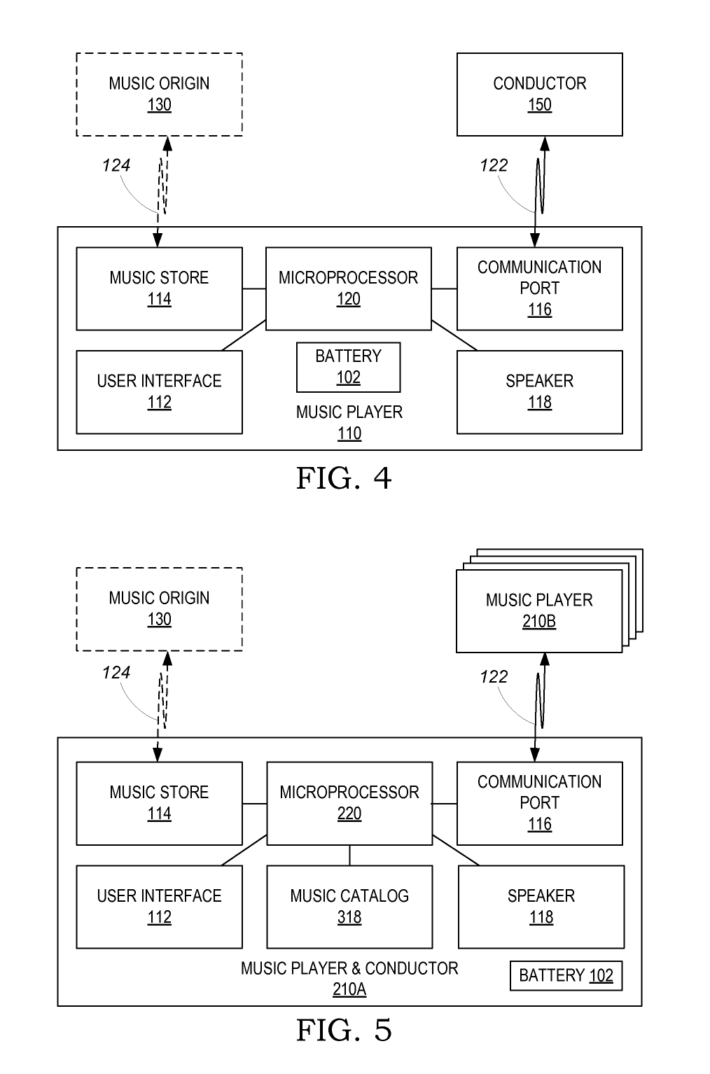

FIG. 4 describes in more detail music players 110 of FIG. 1, which are collectively represented herein by a music player 110. Either during manufacture of music player 110 or by subsequent provisions of cartridges or via Internet or mobile downloads, one or more music pieces are provided from a music origin 130 and are copied into a nonvolatile storage device represented herein by music store 114. Thus, music store 114 can be a ROM (read-only memory) preloaded with music during manufacture of music player 110, a preloaded memory cartridge inserted later, or a nonvolatile memory updated via Internet or mobile-network downloads. If music player 110 is a toy, the music parts stored in music store 114 are preferably adapted to the shape of the musical instrument represented by music player 110; for example, if music player 110 is shaped as a piano toy, the music pieces stored in music store 114 are preferably music parts composed or adapted for a piano. User interface 112 is optionally included in music player 110 for turning the toy on or off, for adjusting a volume level, and preferably also for autonomously playing the music piece or pieces stored in music store 114 without involving other players or a conductor. Communication port 116 receives instructions via link 122 from conductor 150, specifying, for example, which of the music pieces stored in music store 114 to play, and when. Speaker 118 sounds the music stored in music store 114 as selected and/or activated by conductor 150. Microprocessor 120 manages and coordinates the operations of the other units of music player 110, as depicted above. Battery 102 energizes music player 110. It will be noted that speaker 118 can be a loudspeaker of conventional design, or can be a microprocessor-controlled electromechanical instrument such as drums or cymbals actuated by electromagnets; it can also include visual effects, such as lights, that illuminate in sync with the played music piece. In all cases, speaker 118 includes also the necessary circuitry for transforming digital signals received from the respective microprocessor into sound.

FIG. 5 describes in more detail music player & conductor 210A of FIG. 2. Music store 114 and speaker 118 are as depicted with respect to FIG. 4. User interface 112 includes both the functionalities of user interface 112 of FIG. 4, and user controls for activating all music players 210B via link 122. Music catalog 318 includes the titles of all compositions included in system 200 of FIG. 2 (see also FIG. 10). Microprocessor 220 is programmed for executing both the functionalities of a music player (similar to music player 110 of FIG. 4) and conductor 150. Battery 102 energizes the music player & conductor 210A. Music players 210B are constructed similarly to music player 110 of FIG. 4 or music player & conductor 210A of the present figure.

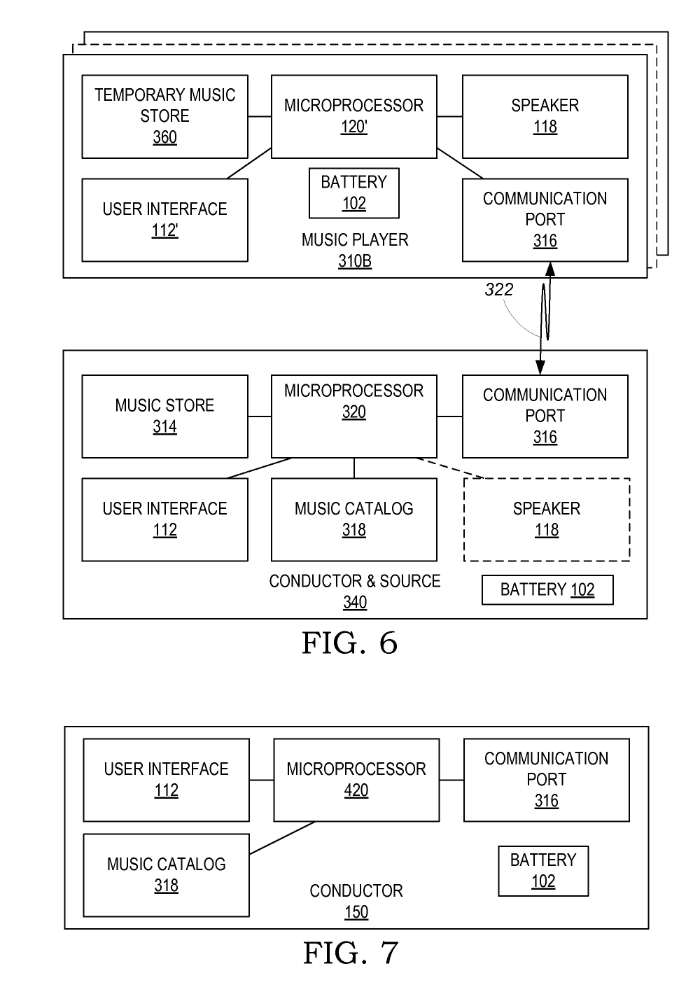

FIG. 6 describes in more detail conductor & source 340 of FIG. 3, configured for initially distributing music pieces and subsequently activating their playing. In the present embodiment, each music player 310B initially receives its respective music piece into its temporary music store 360 from conductor & source 340. Temporary music store 360 is a nonvolatile or volatile memory adapted to store one or more music pieces received from the music store 314 of conductor & source 340, and then replace them with another or other music pieces upon an instruction from conductor & source 340. If it is desirable to further minimize the capacity of temporary music store 360, files of music pieces stored in music store 314 can, in some embodiments, be broken by conductor & sources 340 into contiguous fractions of minimal capacity (e.g. of 512 bytes each), and then each such fraction can be distributed and activated as if it were a music piece by itself. Conductor & source 340 may function also as one of the players of system 300, in which case it includes speaker 118. User interface 112′ of music players 310B is primarily an on-off switch, to save battery 102 power. Music store 314 thus receives from music origin 130 (not shown in the present figure) and stores the music pieces for music players 310B; it can also receive and store a music catalog 318 for its conductor functionality, and also music pieces to be played by conductor & source 340 if it includes player functionality and a speaker 118. Music store 314 can be a preinstalled ROM, a removable memory cartridge, or an updatable nonvolatile memory, as described above with respect to music store 114. User interface 112 provides user controls and functionalities for controlling the cooperative harmonious operation of music players 310B and optionally also the music player functionality of conductor & source 340 itself, if such functionality is included. Microprocessor 320 manages and coordinates the operations of the other units of conductor & source 340, and battery 102 is included to energize all units of conductor & source 340.

FIG. 7 describes in more detail conductor 150 of FIG. 1. User interface 112 allows the user to select a preferred music composition from music catalog 318 (in the case that more than one composition is included in the system, see FIG. 10), and control start/pause/resume/stop playing. Music catalog 318 includes information about all music pieces stored in all music players of the system. Communication port 316 interfaces via link 122 with music players 110 to control their operation (see FIG. 1). Microprocessor 420 manages and coordinates the operations of the other units of conductor 150, as depicted above. Battery 102 energizes all components of conductor 150.

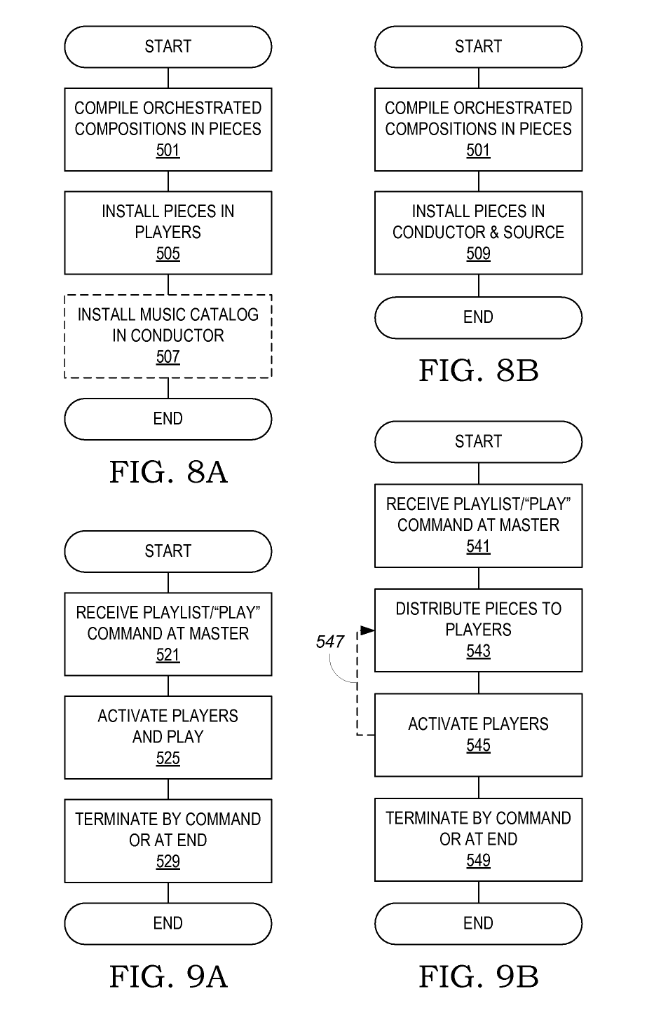

FIG. 8A describes the process of installing music data in the players and conductors of the embodiments of FIGS. 1-2 and 4-5. In a step 501, one or more orchestrated compositions are digitally complied into pieces, using techniques and tools known in the art, each piece representing a music part from a composition that is adapted for being played by a specific music player from music players 110 or music player & conductor 210A. Possibly, more than one composition is compiled, yielding a plurality of music pieces adapted for and related to each music player. Optionally, a music catalog that depicts the various compositions is also included in the compilation. Still in step 501, the various pieces and catalogs are stored in music origin 130. In a step 505, that takes place either when the music players are manufactured, or by using a memory cartridge, or later via Internet or mobile download, the various music pieces are copied from music origin 130 to the respective music players (e.g. the piano part is copied to a music player that represent a piano). In an optional step 507, a catalog is copied from music origin 130 to a standalone conductor 150 (FIG. 1) or to music player & conductor 210A (FIG. 2).

FIG. 8B describes a process of installing music in the players and conductors of the embodiments of FIGS. 3 and 6. Step 501 is the same as step 501 of FIG. 8A, ending up with music pieces, and possibly catalogs, stored in music origin 130. However, in a step 509, all pieces are copied to conductor & source 340 (FIGS. 3 and 6) instead of the individual music players 310B.

FIG. 9A describes the operation of the embodiments of FIGS. 1-2 and 4-5. In a step 521, a user command to play a music piece is received at either conductor 150 of FIG. 1 or music player & conductor 210A of FIG. 2. The user command optionally includes a selection of a specific composition, if more than one composition is stored in the system, or specifies a playlist, i.e. a list of compositions to be played consecutively or randomly. In a step 525, conductor 150 or music player & conductor 210A activates the respective players to play the selected music piece (or several pieces, in case of a playlist); in the case of the preferred embodiment of FIG. 1 this is done by sending activation signals to music players 110 via links 122; in the case of the preferred embodiment of FIG. 2, the activation command from music player & conductor 210A is executed by microprocessor 220 and speaker 118 (FIG. 5) of music player 210A via an internal communication bus while the other music players 210B are activated via activation signals sent through links 122 of FIG. 5. In both cases, the participating players synchronously start to play the selected music pieces, thus providing the desired harmonious music that is an object of the present invention. In a step 529 playing is terminated by all players either at the end of the music pieces or in response to a ‘pause’ or ‘stop’ user command entered at either conductor 150 or music player & conductor 210A.

FIG. 9B describes the operation of the embodiments of FIGS. 3 and 6. In a step 541, a user command to play a music piece is received at conductor & source 340 of FIG. 6. The user command optionally includes a selection of a specific composition, if more than one composition is stored in pieces in music store 314, or specifies a playlist of compositions to be played sequentially or randomly. In a step 543, the music pieces related to the selected orchestrated composition (or currently selected orchestrated composition, in case of a playlist) are copied from music store 314 to the respective temporary music stores 360 of the participating players. In a step 545, conductor & source 340 activates the respective players to synchronously play their prices, thus providing the desired harmonious music that is an object of the present invention. In case of a playlist selected in step 541, loop 547 repeats loading and playing the compositions in the playlist until the playlist is exhausted. In a step 549 playing is terminated by all players either at the end of the music pieces or in response to a user command entered at conductor & source 340.

FIG. 10 schematically describes the distribution of music pieces that relate to several compositions to the music stores 114 of a plurality of players, under the embodiments of FIGS. 1-6. It also describes the content of music store 314 of conductor & source 340 in the embodiments of FIGS. 3 and 6. Thus, for a system that includes X players, labeled Player-1, Player-2, . . . , Player X, a composition “A” is composed of Piece A-1, Piece A-2, . . . , Piece A-X, that represent respective music parts of the composition, devised to be played simultaneously in harmony. Each piece is assigned to the respective player (i.e. Piece A-3 is assigned to Player 3), and is either stored in that player (the embodiments of FIGS. 1-2 and 4-5) or sent thereto toward playing (the embodiment of FIGS. 3 and 6). Similarly, each player is assigned N music pieces respective to the N compositions. The conductor units, either in the standalone configuration (conductor 150 of FIG. 1) or embedded in a player (such as music player & conductor 210A of FIG. 2 or conductor & source 340) preferably includes a music catalog with the titles of all compositions (Title A-Title N), which allows the user scroll through the titles and select the music piece to be played. The titles may include additional information, such as composer name and playing time, and, in some embodiments where the conductor manages the entry point of individual players, also include a music score for each composition, indicating the entry timing of each player.

FIGS. 11A-11C describe three exemplary user interfaces 112 used in players and conductors of the present invention. FIG. 11A describes a user interface 112A that includes just an on-off switch 602. Such a user interface is suitable for players, for switching them off when not in use to conserve battery power. User interface 112A can be enhanced by including a “play” button for autonomous playback of stored music, and optionally also a volume knob. User interface 112B of FIG. 11B contains a panel 612 with several buttons, which is suitable, for example, for conductor units in a system with factory-installed content, for allowing the user to enter a selected orchestrated composition or compositions to be played. FIG. 11C describes user interface 112C which is suitable for a conductor unit with an updatable content (via download or removable cartridges), includes an LCD display 622 that shows a catalog of available compositions, a scroll wheel 624 that allow selecting a composition for playing or a number of compositions for establishing a playlist, and an OK button 628 to confirm a selection or start playing. Many other alternative designs for user interface 112 for a conductor that allow operations of start, stop, pause, and selection of a single or multiple composition playlists are known from the user interfaces of commercial portable music players.

It will be appreciated that in some compositions only a subset of the players may participate while other players may remain idle. Accordingly, a ‘null music piece’ is a perfectly legitimate music piece for a specific player in a specific orchestrated composition, as long as the composition contains at least two different music pieces that are not null.

It will be noted that the multiple-composition embodiment of FIG. 10 is advantageous but not mandatory; a system of the present invention can be built or configured to store and play the parts of a single composition only, with some (but not all) of the part being identical or similar music pieces played in unison.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A system for playing music, comprising:
a plurality of portable music players, each of said plurality of music players including a music store, said music store containing a respective music piece that is assigned to said music player and is related to a selected orchestrated composition from a number of orchestrated compositions; and
a conductor unit operative to activate each of said plurality of portable music players to synchronously play said respective music piece.

2. The system of claim 1, wherein said conductor unit is a standalone unit that is separate from said plurality of portable music players.

3. The system of claim 1, wherein said conductor unit forms part of one of said plurality of portable music players.

4. The system of claim 1, wherein said conductor unit includes a user interface operative to affect said activation operation.

5. The system of claim 1, wherein said number of orchestrated compositions is one orchestrated composition and said selected orchestrated composition is said one orchestrated composition.

6. The system of claim 1, wherein said number of orchestrated compositions is a plurality of orchestrated compositions, and wherein said conductor unit is also operative to determine said selected orchestrated composition from said plurality of orchestrated compositions.

7. The system of claim 6, wherein said conductor unit includes a user interface to affect said determination operation.

8. The system of claim 6, wherein each music store of said music stores contains a plurality of music pieces, each music piece related to a orchestrated composition from said plurality of orchestrated compositions.

9. The system of claim 6, wherein said conductor unit stores music pieces for all music players and all orchestrated compositions, and, prior to said activation of said players, said conductor unit sends said respective music pieces related to said selected orchestrated composition to said music stores of said plurality of music players.

10. The system of claim 6, wherein said conductor unit is also operative to receive a playlist, and said determination of said selected orchestrated composition is affected by said playlist.

11. The system of claim 1, further comprising a music origin device for providing said music pieces for all orchestrated compositions and all players.

12. The system of claim 1 wherein said music store is a removable memory cartridge.

13. The system of claim 9 wherein said conductor unit stores said music pieces, for all music players and all orchestrated compositions, in a removable memory cartridge.

14. A method for playing music, comprising:
installing, in each music player from a plurality of portable music players, a respective music piece related to a selected orchestrated composition from a number of orchestrated compositions; and
activating each of said plurality of music players to synchronously play said respective music piece.

15. The method of claim 14, further comprising receiving a user command to affect said activating.

16. The method of claim 14, wherein said number of orchestrated compositions is one orchestrated composition and said selected orchestrated composition is said one orchestrated composition.

17. The method of claim 14, wherein said number of orchestrated compositions is a plurality of orchestrated compositions, further comprising determining said selected orchestrated composition from said plurality of orchestrated compositions.

18. The method of claim 17, further comprising receiving a user command to affect said determining.

19. The method of claim 17, further comprising, prior to said activation of said players, sending said respective music pieces, related to said selected orchestrated composition, to said respective music players.

20. The method of claim 17, further comprising receiving a playlist, and wherein said determining is responsive to said playlist.
